(19) United States
(12) Patent Application Publication
(10) Pub. No.: US 2019/0283742 A1
(43) Pub. Date: Sep. 19, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Koji Kawabe, Wako-shi (JP); Hideki Matsunaga, Wako-shi (JP); Masamitsu Tsuchiya, Wako-shi (JP); Yasuharu Hashimoto, Wako-shi (JP); Etsuo Watanabe, Wako-shi (JP)

(21) Appl. No.: 16/297,795

(22) Filed: Mar. 11, 2019

(30) Foreign Application Priority Data
Mar. 14, 2018 (JP) 2018-046882

(51) Int. Cl. B60W 30/09; B60W 10/04; B60W 10/20; B60W 30/095; G08G 1/16; G05D 1/02

(52) U.S. Cl. CPC B60W 30/09; B60W 10/04; B60W 10/20; G06N 3/08; G08G 1/166; G05D 1/0214; G05D 1/0223; B60W 30/0956

(57) ABSTRACT

Provided is an automatic driving control device (100) including: a recognition unit (130) that recognizes a nearby situation of a vehicle; a driving control unit (140, 160) that automatically controls acceleration/deceleration and steering of the vehicle on the basis of the nearby situation that is recognized by the recognition unit; an output unit that outputs information; and a notification control unit (180) that controls the output unit to notify a traffic participant of existence of the vehicle in a case where the traffic participant who exists in an advancing direction of the vehicle is recognized by the recognition unit. The notification control unit adjusts the degree of notification with respect to the traffic participant on the basis of a distance between an edge portion that is disposed away from the traffic participant in a width direction of a road on which the vehicle travels, and the traffic participant.

### CROSS-REFERENCE TO RELATED APPLICATION

Priority is claimed on Japanese Patent Application No. 2018-046882, filed Mar. 14, 2018, the content of which is incorporated herein by reference.

### BACKGROUND

### Field of the Invention

The present invention relates to a vehicle control device, a vehicle control method, and a storage medium.

### Description of Related Art

In the related art, a host vehicle existence notification device that is used for a vehicle such as an electric vehicle of which a driving sound is very small and notifies pedestrians near a host vehicle of existence of the host vehicle with a physical sound is known (for example, Japanese Unexamined Patent Application, First Publication No. 2009-67382). Patent Document 1 discloses a technology of operating physical sound generating means for giving a notification of existence of a host vehicle by using a physical sound such as an engine sound (operation sound) and a road noise generated due to change of a tire pressure in vehicle travel, and the like, and of notifying pedestrians of the existence of the host vehicle.

### SUMMARY

However, in the technology of the related art, there is no consideration for appropriate determination of a notification aspect for traffic participants on the basis of a relationship between a host vehicle and the traffic participants such as pedestrians when avoiding the pedestrians.

The invention has been made in consideration of such circumstances, and an object thereof is to provide a vehicle control device capable of more appropriately determining a notification aspect for traffic participants, a vehicle control method, and a storage medium.

The vehicle control device, the vehicle control method, and the storage medium according to the invention have employed the following configurations.

(1) According to an aspect of the invention, there is provided a vehicle control device including: a recognition unit that recognizes a nearby situation of a vehicle; a driving control unit that controls acceleration/deceleration and steering of the vehicle on the basis of the nearby situation that is recognized by the recognition unit; an output unit that outputs information; and a notification control unit that controls the output unit to output information for notification of existence of the vehicle to a traffic participant in a case where the traffic participant who exists in an advancing direction of the vehicle is recognized by the recognition unit. The notification control unit adjusts the degree of notification with respect to the traffic participant on the basis of a distance between an edge portion that is disposed away from the traffic participant in a width direction of a road on which the vehicle travels, and the traffic participant.

(2) In the vehicle control device according to the aspect (1), the notification control unit may not allow the output unit to output information in a case where the distance recognized by the recognition unit is equal to or greater than a first determined distance, and the notification control unit may allow the output unit to output information on the basis of a predetermined condition in a case where the distance recognized by the recognition unit is less than the first predetermined distance.

(3) In the vehicle control device according to the aspect (1), in a case where the recognition unit recognizes that the traffic participant is not aware of existence of the vehicle after information is output by the output unit at first intensity, the notification control unit may control the output unit to output information at second intensity stronger than the first intensity.

(4) In the vehicle control device according to the aspect (2), in a case where the distance recognized by the recognition unit is less than a first predetermined distance and is equal to or greater than a third predetermined distance shorter than the first predetermined distance, the notification control unit may allow the output unit to output information at first intensity.

(5) In the vehicle control device according to the aspect (4), in a case where an advancing direction of the traffic participant is the same as the advancing direction of the vehicle, and the distance recognized by the recognition unit is less than a second predetermined distance that is shorter than the first predetermined distance and is longer than the third predetermined distance, and is equal to or greater than the third predetermined distance, the driving control unit may allow the vehicle to follow the traffic participant, and after the recognition unit recognizes that the driving control unit allows the vehicle to follow the traffic participant, the notification control unit may allow the output unit to output information at the first intensity.

(6) In the vehicle control device according to the aspect (4), in a case where an advancing direction of the traffic participant is the same as the advancing direction of the vehicle, and the distance recognized by the recognition unit is less than the third predetermined distance, the driving control unit may allow the vehicle to follow the traffic participant, and the notification control unit may not allow the output unit to output information.

(7) In the vehicle control device according to the aspect (1), in a case where the output unit is allowed to output information, and in a case where the recognition unit recognizes that the traffic participant is aware of existence of the vehicle, the notification control unit may allow the output unit to stop outputting of information.

(8) In the vehicle control device according to the aspect (1), in a case where the output unit is allowed to output information for a predetermined output time or longer, and in a case where the recognition unit recognizes that the traffic participant is not aware of existence of the vehicle, the notification control unit may allow the output unit to stop outputting of information.

(9) According to another aspect of the invention, there is provided a vehicle control method including: recognizing a nearby situation of a vehicle by a vehicle control device; automatically controlling acceleration/deceleration and steering of the vehicle by the vehicle control device on the basis of the nearby situation that is recognized; and automatically controlling steering of the vehicle by the vehicle control device to give a notification of existence of the vehicle by adjusting the degree of notification on the basis of a distance between an edge portion that is disposed away from a traffic participant in a width direction of a road on which the vehicle travels, and the traffic participant in a case where the traffic participant who exists in an advancing direction of the vehicle is recognized.

(10) According to still another aspect of the invention, there is provided a non-transitory computer-readable storage medium that stores a program that allows a vehicle control device to: recognize a nearby situation of a vehicle; automatically control acceleration/deceleration and steering of the vehicle on the basis of the nearby situation that is recognized; and automatically control steering of the vehicle to give a notification of existence of the vehicle by adjusting the degree of notification on the basis of a distance between an edge portion that is disposed away from a traffic participant in a width direction of a road on which the vehicle travels, and the traffic participant in a case where the traffic participant who exists in an advancing direction of the vehicle is recognized.

According to the aspects (1) to (10), it is possible to more appropriately determine a notification aspect for traffic participants who exist in an advancing direction of a host vehicle.

### BRIEF DESCRIPTION OF THE DRAWINGS

FIG. 1 is a configuration view of a vehicle system using a vehicle control device according to an embodiment;

FIG. 2 is a functional configuration view of a first control unit and a second control unit;

FIG. 3 is a view showing an example of processing of a traffic participant correspondence control unit in a case where a pedestrian exists in an advancing direction of the host vehicle M;

FIG. 4 is a flowchart showing a part of a flow of processing executed by an automatic driving control device of the embodiment;

FIG. 5 is a flowchart showing a part of a flow of processing executed by the automatic driving control device of the embodiment; and

FIG. 6 is a view showing an example of a hardware configuration of the automatic driving control device of the embodiment.

### DETAILED DESCRIPTION OF THE INVENTION

Hereinafter, an embodiment of a vehicle control device, a vehicle control method, and a program according to the invention will be described with reference to the accompanying drawings. In the following description, description will be given of a case where a left-hand driving law is applied, but in a case where a right-hand driving law is applied, right and left may be switched.

[Overall Configuration]

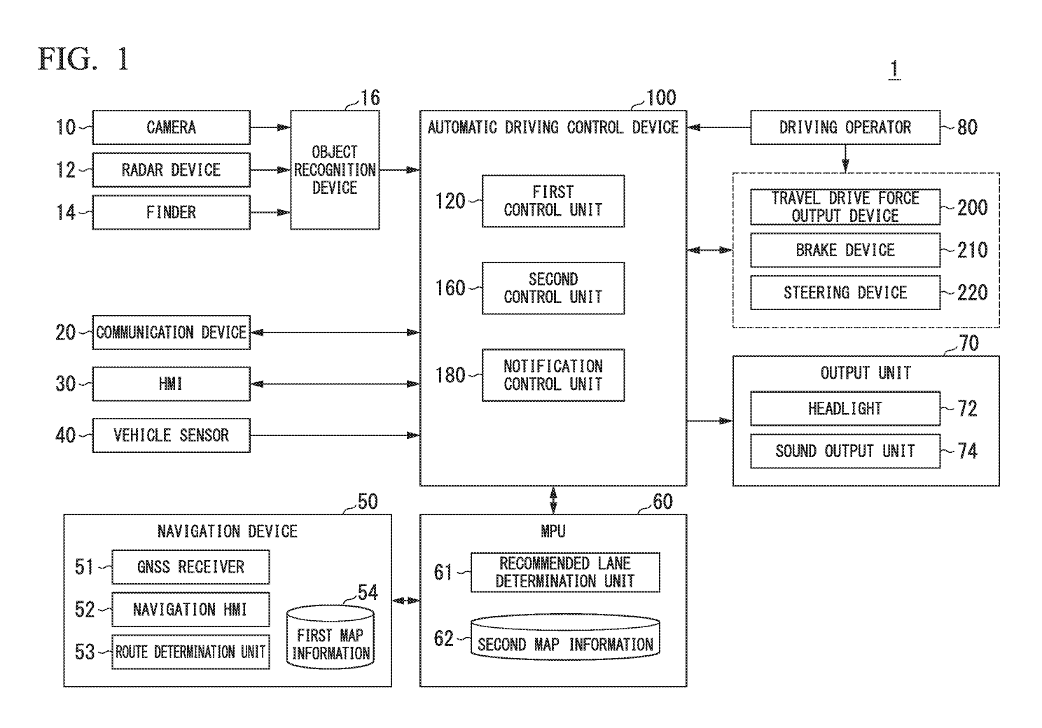

FIG. 1 is a configuration view showing a vehicle system 1 that uses a vehicle control device according to an embodiment. Examples of a vehicle on which the vehicle system 1 is mounted include a two-wheeled vehicle, a three-wheeled vehicle, a four-wheeled vehicle, and the like, and examples of a drive source thereof include an internal combustion engine such as a diesel engine and a gasoline engine, an electric motor, and a combination thereof. The electric motor operates by using electric power generated by a generator connected to the internal combustion engine, or discharged electric power of a secondary battery or a fuel cell.

For example, the vehicle system 1 includes a camera 10, a radar device 12, a finder 14, an object recognition device 16, a communication device 20, a human machine interface (HMI) 30, a vehicle sensor 40, a navigation device 50, a map positioning unit (MPU) 60, an output unit 70, a driving operator 80, an automatic driving control device 100, a travel drive force output device 200, a brake device 210, and a steering device 220. The devices or instruments are connected to each other by a multiplex communication line such as a controller area network (CAN) communication line, a serial communication line, a wireless communication line, and the like. The configuration shown in FIG. 1 is illustrative only, and parts of the configuration may be omitted, or other configurations may be added. The automatic driving control device 100 is an example of a “vehicle control device”.

For example, the camera 10 is a digital still camera using a solid-state imaging element such as a charge coupled device (CCD) and a complementary metal oxide semiconductor (CMOS). The camera 10 is attached to an arbitrary site of a vehicle on which the vehicle system 1 is mounted (hereinafter, referred to as a host vehicle M). In a case of capturing an image on a front side, the camera 10 is attached to an upper portion of a front windshield, a rear surface of a rear view mirror, and the like. For example, the camera 10 periodically and repetitively captures images of the surroundings of the host vehicle M. The camera 10 may be a stereo camera.

The radar device 12 emits radio waves such as a millimeter wave to the periphery of the host vehicle M and detects radio waves (reflected waves) reflected from the object to detect at least a position of the object (a distance and an azimuth). The radar device 12 is attached at an arbitrary site of the host vehicle M. The radar device 12 may detect the position and a speed of the object by a frequency modulated continuous wave (FM-CW) method.

The finder 14 is a light detection and ranging (LIDAR). The finder 14 irradiates the periphery of the host vehicle M with light and measures scattered light. The finder 14 detects a distance to a target on the basis of time from light emission to light reception. For example, irradiation light is pulse-shaped laser light. The finder 14 is attached to an arbitrary site of the host vehicle M.

The object recognition device 16 performs sensor fusion processing with respect to a detection result by some or all of the camera 10, the radar device 12, and the finder 14 to recognize a position, a kind, a speed, and the like of the object. The object recognition device 16 outputs a recognition result to the automatic driving control device 100. The object recognition device 16 may output a detection result of the camera 10, the radar device 12, and the finder 14 to the automatic driving control device 100 as is. The object recognition device 16 may be omitted from the vehicle system 1.

For example, the communication device 20 performs communication with other vehicles near the host vehicle M by using a cellular network, a Wi-Fi network, Bluetooth (registered trademark), dedicated short range communication (DSRC), and the like, or performs communication with various server devices through a wireless base station.

The HMI 30 presents various pieces of information to an occupant of the host vehicle M, and receives an input operation by the occupant. The HMI 30 includes various display devices, a speaker, a buzzer, a touch panel, a switch, a key, and the like.

The vehicle sensor 40 includes a vehicle speed sensor that detects a speed of the host vehicle M, an acceleration sensor that detects acceleration, a yaw rate sensor that detects an angular speed around a vertical axis, and an azimuth sensor that detects a direction of the host vehicle M.

For example, the navigation device 50 includes a global navigation satellite system (GNSS) receiver 51, a navigation HMI 52, and a route determination unit 53. The navigation device 50 retains first map information 54 in a storage device such as a hard disk drive (HDD) and a flash memory. The GNSS receiver 51 specifies a position of the host vehicle M on the basis of a signal that is received from a GNSS satellite. The position of the host vehicle M may be specified or supplemented by an inertial navigation system (INS) using an output of the vehicle sensor 40. The navigation HMI 52 includes a display device, a speaker, a touch panel, a key, and the like. A part or the entirety of the navigation HMI 52 may be common to a part or the entirety of the above-described HMI 30. For example, the route determination unit 53 determines a route (hereinafter, referred to as on-map route) to a destination that is input by an occupant by using the navigation HMI 52 from the position of the host vehicle M which is specified by the GNSS receiver 51 (or an arbitrary position that is input) with reference to the first map information 54. For example, the first map information 54 is information in which a road shape is expressed by a link that represents a road and a node that is connected to the link. The first map information 54 may include a curvature of a road, point of interest (POI) information, and the like. The on-map route is output to the MPU 60. The navigation device 50 may perform route guidance by using the navigation HMI 52 on the basis of the on-map route. For example, the navigation device 50 may be realized by a function of a terminal device such as a smart phone and a tablet terminal which are carried by an occupant. The navigation device 50 may transmit a current position and a destination to a navigation server through the communication device 20, and may acquire the same route as the on-map route from the navigation server.

For example, the MPU 60 includes a recommended lane determination unit 61, and retains second map information 62 in a storage device such as an HDD and a flash memory. The recommended lane determination unit 61 divides the on-map route that is provided from the navigation device 50 into a plurality of blocks (for example, for every 100 [m] in a vehicle advancing direction), and determines a recommended lane for every block with reference to the second map information 62. The recommended lane determination unit 61 determines which lane from the left the vehicle will travel in. In a case where a branch site exists in the on-map route, the recommended lane determination unit 61 determines a recommended lane in order for the host vehicle M to travel along a reasonable route to proceed to a branch destination.

The second map information 62 is map information with higher accuracy in comparison to the first map information 54. For example, the second map information 62 includes lane center information, lane boundary information, and the like. The second map information 62 may include road information, traffic restriction information, address information (addresses, postal codes), facility information, telephone information, and the like. The second map information 62 may be updated at any time through communication between the communication device 20 and other devices.

The output unit 70 is a device capable of outputting information toward the outside of the vehicle. For example, the output unit 70 includes headlights 72, and a sound output unit 74. The headlights 72 are disposed at predetermined sites at the front of the host vehicle M. The headlights 72 are disposed at right and left positions of the host vehicle M. The headlights 72 are right and left headlights which turn on or turn off on the basis of an operation control by a notification control unit 180. With regard to an output of the headlights 72, low beams and high beams can be switched. For example, the low beams light for passing and an irradiation distance is approximately 40 [m] forward. For example, the high beams are light for travel, and an irradiation distance is approximately 100 [m] forward. For example, the sound output unit 74 is a horn or a speaker. The sound output unit 74 initiates or terminates generation of a notification sound on the basis of an operation control by the notification control unit 180.

For example, the driving operator 80 includes an accelerator pedal, a brake pedal, a shift lever, a steering wheel, a steering wheel variant, a joy stick, and other operators. A sensor that detects an operation amount or presence and absence of an operation is attached to the driving operator 80, and a detection result thereof is output to the automatic driving control device 100, or some or all of the travel drive force output device 200, the brake device 210, and the steering device 220.

For example, the automatic driving control device 100 includes a first control unit 120, a second control unit 160, and the notification control unit 180. Each of the configuration elements is realized, for example, when a hardware processor such as a central processing unit (CPU) executes a program (software). Some or all of the constituent elements may be realized by hardware (circuit unit; including circuitry) such as a large scale integration (LSI), an application specific integrated circuit (ASIC), a field-programmable gate array (FPGA), and a graphics processing unit (GPU), or may be realized by software and hardware in cooperation. The program may be stored in a storage device such as the HDD and the flash memory of the automatic driving control device 100 in advance, or may be stored in a detachable storage medium such as a DVD and a CD-ROM and may be installed in the HDD or the flash memory of the automatic driving control device 100 when the storage medium is mounted in a drive device. A combination of an action plan generation unit 140 and the second control unit 160 is an example of “driving control unit”. For example, the driving control unit automatically controls acceleration/deceleration, and steering in a speed or steering of the host vehicle M on the basis of a nearby situation that is recognized by a recognition unit 130.

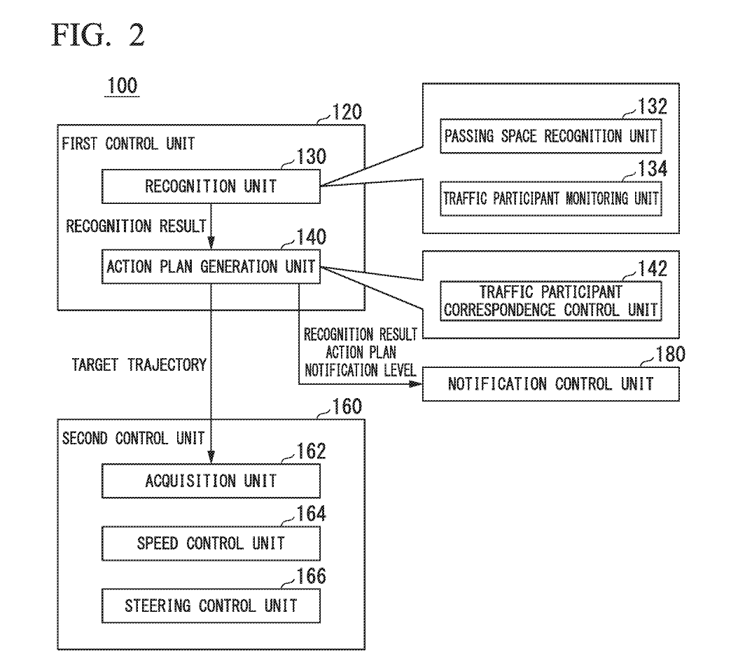

FIG. 2 is a functional configuration view of the first control unit 120, the second control unit 160, and the notification control unit 180. For example, the first control unit 120 includes the recognition unit 130 and the action plan generation unit 140. For example, the first control unit 120 realizes a function by artificial intelligence (AI) and a function by a model that is given in advance in parallel to each other. For example, an “intersection recognition” function may be realized by executing recognition of an intersection through deep learning and recognition based on conditions (including a pattern-matching possible signal, a road sign, and the like) which are given in advance in parallel and by conducting scoring with respect to both recognitions for comprehensive evaluation. According to this, reliability of automatic driving is secured.

The recognition unit 130 recognizes a position, and a state such as a speed and acceleration of an object near the host vehicle M on the basis of information that is input from the camera 10, the radar device 12, and the finder 14 through the object recognition device 16. Examples of the object include a moving body such as a pedestrian, a bicycle, a motor bicycle, another vehicle, and an obstacle such as a construction site. For example, the position of the object is recognized as a position in absolute coordinates in which a representative point of the host vehicle M (the center of gravidity, the center of a driving shaft, and the like) is set as the origin, and is used in control. The position of the object may be shown as a representative point such as the center of gravity and a corner of the object, or may be shown as an expressed region. In a case where the object is the other vehicle, the “state” of the object may include acceleration or a jerk of the object, or an “action state” (for example, a state in which the object is changing lanes, or about to change lanes). In a case where the object is the pedestrian, the “state” of the object may include a direction in which the object moves, or an “action state” (for example, a state in which the object is crossing a road, or about to cross a road). The recognition unit 130 may recognize a movement amount of an object in a sampling period.

For example, the recognition unit 130 recognizes a lane (road) in which the host vehicle M is travelling. For example, the recognition unit 130 recognizes the travel lane through pattern comparison between a pattern (for example, an arrangement of a solid line and a broken line) of a road partition line obtained from the second map information 62, and a pattern of a nearby road partition line of the host vehicle M which is recognized from an image captured by the camera 10. The recognition unit 130 may recognize the travel lane by recognizing a running road boundary (road boundary) including the road partition line, a side road, a curbstone, a median strip, a guard rail, a concrete block wall, a side groove, a fence, and the like without limitation to the road partition line. In the recognition, the position of the host vehicle M which is acquired from the navigation device 50, or a processing result by the INS may be added. The recognition unit 130 recognizes a width of a road on which the host vehicle M travels. In this case, the recognition unit 130 may recognizes the road width from an image that is captured by the camera 10, or may recognize the road width from the road partition line that is obtained from the second map information 62. The recognition unit 130 may recognize a width (for example, a vehicle width of the other vehicle), a height, a shape, and the like of the obstacle on the basis of the image that is captured by the camera 10. The recognition unit 130 recognizes a temporary stop line, a red sign, a tollgate, and other road events.

The recognition unit 130 recognizes a position or a posture of the host vehicle M with respect to the travel lane when recognizing the travel lane. For example, the recognition unit 130 may recognize a deviation of the host vehicle M from the center of a lane which is a representative point, and an angle of the host vehicle M with respect to a line that straightly connects the center of a lane in an advancing direction of the host vehicle M as a relative position and a posture of the host vehicle M with respect to the travel lane. Alternatively, the recognition unit 130 may recognize a position of a representative point of the host vehicle M with respect to an arbitrary side edge portion (a road partition line or a road boundary) of the travel lane, and the like as the relative position of the host vehicle M with respect to the travel lane. The recognition unit 130 may recognize a structure (for example, an electric pole, a median strip, and the like) on a road on the basis of the first map information 54 or the second map information 62. Functions of a passing space recognition unit 132 and a traffic participant monitoring unit 134 of the recognition unit 130 will be described later.

The action plan generation unit 140 generates a target trajectory along which the host vehicle M automatically travels in the future (without depending on an operation by a driver) so that the host vehicle M principally travels a recommended lane determined by the recommended lane determination unit 61 and the host vehicle M can cope with a nearby situation of the host vehicle M. The target trajectory is a target trajectory through which a representative point of the host vehicle M passes. For example, the target trajectory includes a speed element. For example, the target trajectory is expressed by sequentially arranging points (trajectory points) which the host vehicle M will reach. The trajectory points are points which the host vehicle M will reach for every predetermined travel distance (for example, approximately several [m]) in a distance along a road, and a target speed and target acceleration for predetermined sampling time (for example, approximately zero point several [sec]) are additionally generated as a part of the target trajectory. The trajectory points may be positions which the host vehicle M will reach at a sampling time for predetermined sampling time. In this case, information of the target speed or the target acceleration is expressed as an interval of the trajectory points.

The action plan generation unit 140 may set an automatic driving event when generating the target trajectory. Examples of the automatic driving event include a constant speed travel event, a low-speed following travel event, a lane changing event, a branching event, a merging event, a take-over event, and the like. The action plan generation unit 140 generates a target trajectory associated with an activated event. Functions of a traffic participant correspondence control unit 142 of the action plan generation unit 140 will be described later.

The second control unit 160 controls the travel drive force output device 200, the brake device 210, and the steering device 220 so that the host vehicle M passes through a target trajectory generated by the action plan generation unit 140 at on a scheduled time.

For example, the second control unit 160 includes an acquisition unit 162, a speed control unit 164, and a steering control unit 166. The acquisition unit 162 acquires information of a target trajectory (trajectory points) generated by the action plan generation unit 140, and stores the information in a memory (not shown). The speed control unit 164 controls the travel drive force output device 200 or the brake device 210 on the basis of a speed element associated with the target trajectory that is stored in the memory. The steering control unit 166 controls the steering device 220 in correspondence with a curve state of the target trajectory stored in the memory. Processing of the speed control unit 164 and the steering control unit 166 is realized, for example, by a combination of feed forward control and feedback control. As an example, the steering control unit 166 executes feed forward control associated with a curvature of a road in front of the host vehicle M, and feedback control based on a deviation from the target trajectory in combination with each other.

The travel drive force output device 200 outputs a travel drive force (torque) necessary for vehicle travel to driving wheels. For example, the travel drive force output device 200 includes a combination of an internal combustion engine, an electric motor, and a transmission, and an ECU that controls these components. The ECU controls the components in accordance with information input from the second control unit 160, or information that is input from the driving operator 80.

For example, the brake device 210 includes a brake caliper, a cylinder that transmits a hydraulic pressure to the brake caliper, an electric motor that generates the hydraulic pressure in the cylinder, and a brake ECU. The brake ECU controls the electric motor in accordance with information that is input from the second control unit 160 or the information that is input from the driving operator 80, and allows brake torque associated with a braking operation to be output to respective wheels. The brake device 210 may include a mechanism that transmits a hydraulic pressure generated by an operation of a brake pedal included in the driving operator 80 to the cylinder through a master cylinder as a backup mechanism. The brake device 210 may be an electromagnetic control type hydraulic pressure brake device that controls an actuator in accordance with information input from the second control unit 160 and transmits a hydraulic pressure of the master cylinder to the cylinder without limitation to the above-described configuration.

For example, the steering device 220 includes a steering ECU and an electric motor. For example, the electric motor applies a force to a rack and pinion mechanism to change a direction of front steering wheels. The steering ECU drives the electric motor in accordance with information input from the second control unit 160 or information input from the driving operator 80 to change the direction of the front steering wheels.

[With Regard to Control When Passing Traffic Participant]

Hereinafter, description will be given of a series of processing that is executed by the vehicle system 1 when passing a traffic participant.

(Function of Passing Space Recognition Unit)

For example, in a case where the recognition unit 130 recognizes that in an advancing direction of a road on which the host vehicle M travels, a traffic participant, who advances in the same direction, other the host vehicle M exists, the passing space recognition unit 132 organizes position information of the traffic participant, and recognizes a space necessary for the host vehicle M to travel by bypassing the traffic participant. For example, the traffic participant represents a single or a plurality of moving bodies such as a pedestrian, a bicycle, and a motor bicycle, which exist in a travel lane of the host vehicle M, among objects recognized by the recognition unit 130. In the following description, description will be made on the assumption that the traffic participant is a single pedestrian (hereinafter, referred to as “pedestrian”) as a representative traffic participant. In the following description, description will be given of a case of passing a pedestrian who moves only in the same direction as an advancing direction of the host vehicle M will be shown and described, but this is also applicable to, for example, a case of bypassing a traffic participant who moves in a direction opposite to the advancing direction of the host vehicle M or a stopped traffic participant without limitation thereto.

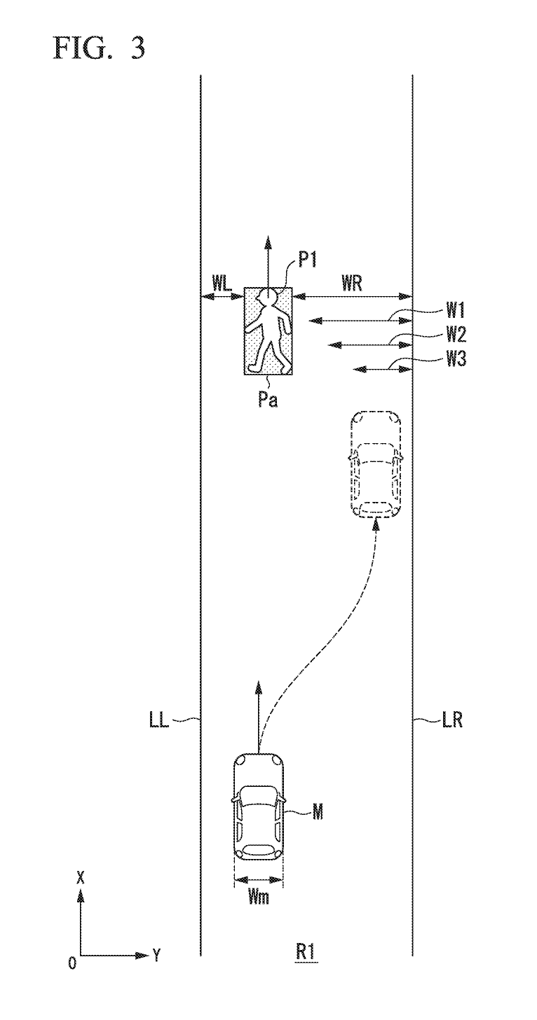

FIG. 3 is a view showing an example of processing of the first control unit 120, the second control unit 160, and the notification control unit 180 in a case where a pedestrian exists in an advancing direction of the host vehicle M. In the example of FIG. 3, it is assumed that a pedestrian P1 exists in an advancing direction (X-axis direction) of the host vehicle M that travels on a road R1 that is partitioned by left and right road partition lines LL and LR and has a vehicle width Wm. In the examples of FIG. 3, it is assumed that the host vehicle M performs passing driving by passing through a right side of the pedestrian P1.

For example, in a case where the pedestrian P1 who exists in the advancing direction of the host vehicle M is recognized by the recognition unit 130, the passing space recognition unit 132 sets a contact estimation region Pa that is estimated to have a possibility of contact with the pedestrian P1 on the basis of contour information of the pedestrian P1. A gap WL between a left edge of the contact estimation region Pa and the road partition line LL, and a gap WR between a right edge of the contact estimation region Pa and the road partition line LR are derived. The passing space recognition unit 132 outputs the gaps WL and WR which are derived, and the contact estimation region Pa to the action plan generation unit 140. In the example of FIG. 3, it is assumed that the gap WR is greater than the gap WL.

In the example of FIG. 3, in a case where the travel road of the host vehicle M is a road without a central line although recognizing the gaps WR and WL on the basis of a gap between the partition lines LL and LR which are side edge portions of a travel lane in which the host vehicle M travels, the passing space recognition unit 132 recognizes the gaps WR and WL on the basis of an edge on an opposite lane side. In a case where the travel road of the host vehicle M is a road having a central line or a median strip, the gaps WR and WL are recognized on the basis of the central line or the median strip.

(Function of Traffic Participant Monitoring Unit)

The traffic participant monitoring unit 134 determines whether or not the pedestrian P1 is aware of existence of the host vehicle M. Determination as to whether or not the pedestrian P1 is aware of existence of the host vehicle M may be derived from a result obtained by analyzing a behavior of the pedestrian P1 recognized by the recognition unit 130 within a constant time by using an AI function of the first control unit 120. Examples of a behavior that is determined as a behavior in which the pedestrian P1 is aware of existence of the host vehicle M include a motion in which the pedestrian P1 stops, and a motion in which the pedestrian P1 faces a direction of the host vehicle M.

In a case where existence of the pedestrian P1 in the advancing direction of the host vehicle M is recognized by the recognition unit 130, the traffic participant monitoring unit 134 may estimate a movement amount xp1 related to a direction (lateral direction) orthogonal to the advancing direction of the host vehicle M in a movement amount of the pedestrian P to determine whether or not the pedestrian P1 is aware of existence of the host vehicle M. For example, the movement amount xp1 is a movement amount of the pedestrian P1 in the lateral direction from an inner side (for example, a road center) of the road R1 toward an outer side (for example, the partition line LL). The movement amount xp1 may be a movement amount of the pedestrian P1 in a direction to be distant from a side that is passed by the host vehicle M.

The traffic participant monitoring unit 134 repetitively makes a determination as to whether or not the pedestrian P1 is aware of existence of the host vehicle M with constant intervals, and outputs the latest determination result to the action plan generation unit 140 for every determination.

(Function of Traffic Participant Correspondence Control Unit)

The traffic participant correspondence control unit 142 selects and controls an appropriate correspondence with respect to the pedestrian P1 on the basis of various pieces of information which are input from the passing space recognition unit 132. In the example of FIG. 3, the gap WR is greater than the gap WL, and the edge portion is disposed away from the traffic participant, and thus the traffic participant correspondence control unit 142 performs the following processing on the assumption that the host vehicle M bypasses the pedestrian P1 through the right side.

The action plan generation unit 140 sets a notification level and a notification timing which are correlated to an automatic driving event when travelling along a target trajectory. The notification level is the degree of notification in a case of performing notification to the traffic participant in conjunction with automatic driving in the automatic driving event. Hereinafter, description will be given of an example in which the notification level that is set by the traffic participant correspondence control unit 142 is set to three levels (“non-notification”, “first intensity”, and “second intensity”). In the notification level, the degree of notification is stronger in the order of “non-notification”<“first intensity”<“second intensity”. For example, even in a case where the action plan generation unit 140 sets the notification level to the first strength, the notification timing is set to estimate an execution timing of output of notification information without a particular standby time, or output of notification information after following the pedestrian P1 for a constant time before outputting the notification information.

(Determination Processing by Traffic Participant Correspondence Control Unit)

Hereinafter, description will be given of processing of determining whether or not the host vehicle M can pass the pedestrian P1 by the traffic participant correspondence control unit 142 on the basis of the gap WR.

For example, the traffic participant correspondence control unit 142 determines whether or not the gap WR is equal to or greater than a first predetermined distance W1. For example, the first predetermined distance W1 is a distance at which a possibility of contact between the pedestrian P1 and the host vehicle M is sufficiently low when the host vehicle M passes the pedestrian P1 even in a case where the pedestrian P1 is not aware of the host vehicle M. For example, the first predetermined distance W1 is the sum of the vehicle width Wm of the host vehicle M and a distance α1. The distance α1 may be a fixed distance (for example, 70 [cm]). The distance α1 may be derived from a gap based on a stride of the pedestrian P1 which is recognized by the recognition unit 130.

In a case where it is determined that the gap WR is equal to or greater than the first predetermined distance W1, the traffic participant correspondence control unit 142 determines that the host vehicle M can pass the pedestrian P1, and sets the notification level to the non-notification. In a case where it is determined that the gap WR is less than the first predetermined distance W1, the traffic participant correspondence control unit 142 further makes the following determination by using the first predetermined distance W1 and a second predetermined distance W2 as a determination standard.

For example, the traffic participant correspondence control unit 142 determines whether or not the gap WR is less than the first predetermined distance W1 and equal to or greater than the second predetermined distance W2. The second predetermined distance W2 is a distance at which a possibility of contact between the pedestrian P1 and the host vehicle M is sufficiently low when the host vehicle M passes the pedestrian P1 in a case where the pedestrian P1 is aware of the host vehicle M. For example, the second predetermined distance W2 is the sum of the vehicle width Wm of the host vehicle M and a distance α2. The distance α2 is a distance shorter than the distance α1. The distance α2 may be a fixed gap (for example, approximately 30 [cm]). As in the distance α1, the distance α2 may be derived from a gap based on the stride of the pedestrian P1 which is recognized by the recognition unit 130. The condition of “the gap WR is less than the first predetermined distance W1 and equal to or greater than the second predetermined distance W2” that is used in setting of the notification level by the traffic participant correspondence control unit 142 is an example of “predetermined condition”.

In a case where it is determined that the gap WR is less than the first predetermined distance W1 and equal to or greater than the second predetermined distance W2, the traffic participant correspondence control unit 142 determines that the host vehicle M can pass the pedestrian P1, and sets the notification level to the first intensity. In a case where it is determined that the gap WR is less than the second predetermined distance W2, the traffic participant correspondence control unit 142 further makes the following determination by using the second predetermined distance W2 and a third predetermined distance W3 as the determination standard.

For example, the traffic participant correspondence control unit 142 determines whether or not the gap WR is less than the second predetermined distance W2 and equal to or greater than the third predetermined distance W3. The third predetermined distance W3 is a distance at which a probability of contact between the pedestrian P1 and the host vehicle M is a predetermined probability or greater when the host vehicle M passes the pedestrian P even in a case where the pedestrian P1 is aware of the host vehicle M. For example, the third predetermined distance W3 may be the vehicle width Wm of the host vehicle M, or a distance obtained by adding, for example, approximately 10 [cm] to the vehicle width Wm of the host vehicle M. The condition of “the gap WR is less than the second predetermined distance W2 and equal to or greater than the third predetermined distance W3” used by the traffic participant correspondence control unit 142 in setting of the notification level is another example of the “predetermined condition”.

In a case where it is determined that the gap WR is less than the second predetermined distance W2 and equal to or greater than the third predetermined distance W3, the traffic participant correspondence control unit 142 determines that the host vehicle M can pass the pedestrian P1, and sets the notification level to the first intensity. In a case where it is determined that the gap WR is less than the second predetermined distance W2 and equal to or greater than the third predetermined distance W3, the traffic participant correspondence control unit 142 sets the notification timing to “notification will be given after following the pedestrian P1 for a constant time”. In a case where it is determined that the gap WR is less than the third predetermined distance W3, the traffic participant correspondence control unit 142 determines that the host vehicle M cannot pass the pedestrian P1. In a case where it is determined that the host vehicle M cannot pass the pedestrian P1, the traffic participant correspondence control unit 142 selects “the host vehicle M follows the pedestrian P1 while maintaining an appropriate distance”, and sets the notification level to the non-notification.

(Processing of Generating Target Trajectory by Traffic Participant Correspondence Control Unit)

In a case where it is determined that the host vehicle M can pass the pedestrian P1, the traffic participant correspondence control unit 142 generates a bypass travel trajectory. In a case where it is determined that the host vehicle M cannot pass the pedestrian P1, the traffic participant correspondence control unit 142 generates a following travel trajectory.

(Function of Notification Control Unit)

The notification control unit 180 outputs notification information associated with the notification level at a predetermined timing on the basis of the notification level that is input from the action plan generation unit 140.

For example, in a case where the notification level of the first intensity is input from the action plan generation unit 140, the notification control unit 180 instructs the output unit 70 to output information in which the notification level is correlated to the first intensity. Output of the information in which the notification level is correlated to the first intensity represents information output that is performed to allow the pedestrian P1 to be aware of existence of the host vehicle M. Examples of output of information in which the notification level is correlated to the first intensity includes a situation in which the sound output unit 74 makes a sound for only approximately 0.5 to 1 [second], and a situation in which the headlights 72 are set to passing. The passing represents an output in which the headlights 72 are instantly lighted with high beams. Output of the notification information by the headlights 72 and the sound output unit 74 may be performed independently or simultaneously.

For example, in a case where the notification level of the second intensity is input from the action plan generation unit 140, the notification control unit 180 instructs the output unit 70 to output information in which the notification level is correlated to the second intensity. Examples of output of information in which the notification level is correlated to the second intensity includes a situation in which the sound output unit 74 makes a sound for several [seconds], and a situation in which passing of the headlights 72 is performed a plurality of times.

For example, in a case where the notification level of the non-notification is input from the action plan generation unit 140, the notification control unit 180 does not instruct the output unit 70 to output notification information.

(Appropriate Notification Control)

It cannot be said that the notification level set by the action plan generation unit 140 is always appropriate. Accordingly, the notification control unit 180 appropriately changes the notification level on the basis of a determination result as to whether or not the pedestrian P1 is aware of the host vehicle M as a result output from the traffic participant monitoring unit 134. An example of a situation in which the notification control unit 180 changes the notification level will be described below.

(Control of Lowering Notification Level)

First, description will be given of control in which the notification control unit 180 lowers the notification level. For example, even in a case where the pedestrian P1 shows an arbitrary reaction with respect to notification (horn or passing) by the host vehicle M, if the notification continues, it is considered that the pedestrian P1 may feel uncomfortable with respect to the notification by the host vehicle M. Accordingly, in a case where a notification result representing that the pedestrian P1 is already aware of existence of the host vehicle M is input by the traffic participant monitoring unit 134, the notification control unit 180 changes the notification level to the non-notification, and stops an output that is currently performed so as not to take an excessive intimidating attitude with respect to the pedestrian P1. For example, even in a case where the traffic participant correspondence control unit 142 determines that the gap WR becomes broader as a result of movement of the pedestrian P1 in a direction of avoiding the host vehicle M, the notification control unit 180 changes the notification level to the non-notification, and stops an output that is currently performed. The notification control unit 180 may notify a driver of a situation in which the notification level is lowered, for example, through the HMI 30.

In a case where the traffic participant monitoring unit 134 determines that the pedestrian P1 is already aware of existence of the host vehicle M, and an output of the notification information to the pedestrian P1 is scheduled, the notification control unit 180 may stop the output that is scheduled.

(Control of Raising Notification Level)

Next, description will be given of control in which the notification control unit 180 raises the notification level. For example, even after the notification information of the first intensity is output, in a case where the traffic participant monitoring unit 134 does not determine that the pedestrian P1 is aware of the host vehicle M, the notification control unit 180 changes the notification level to the second intensity to gradually intensify the degree of the notification.

However, in a case where the traffic participant monitoring unit 134 determines that the pedestrian P1 is aware of the host vehicle M as an output result of the notification information of the second intensity, the notification control unit 180 changes the notification level to the non-notification, and stops an output that is currently performed. For example, even in a case where the traffic participant correspondence control unit 142 determines that the gap WR becomes wider as a result of movement of the pedestrian P1 in a direction of avoiding the host vehicle M, similarly, the notification control unit 180 determines that the pedestrian P1 is aware of the host vehicle M, changes the notification level to the non-notification, and stops an output that is currently performed.

Even in a case where the traffic participant monitoring unit 134 determines that the pedestrian P1 is not aware of the host vehicle M as an output result of the notification information of the second intensity, the notification control unit 180 continues the output of the notification information of the second intensity without changing the notification level. However, to prevent the notification with respect to the pedestrian P1 from the host vehicle M from being given in an excessive and intimidating manner, the notification control unit 180 may terminate the output of the notification information in a case where a predetermined output time from output initiation of the notification information (for example, approximately 30 [seconds] from output initiation) has passed.

In a case where the output of the notification information to the pedestrian P1 by the output unit 70 is not performed, to prevent an excessive and intimidating behavior, the notification control unit 180 may follow the pedestrian P1 for a constant time or may temporarily stop to adjust a gap between the pedestrian P1 and the host vehicle M. For example, the notification control unit 180 may give a chance for the pedestrian P1 to be aware of the host vehicle M by performing the output of the notification information after following the pedestrian P1 for a constant time.

[Processing Flow]

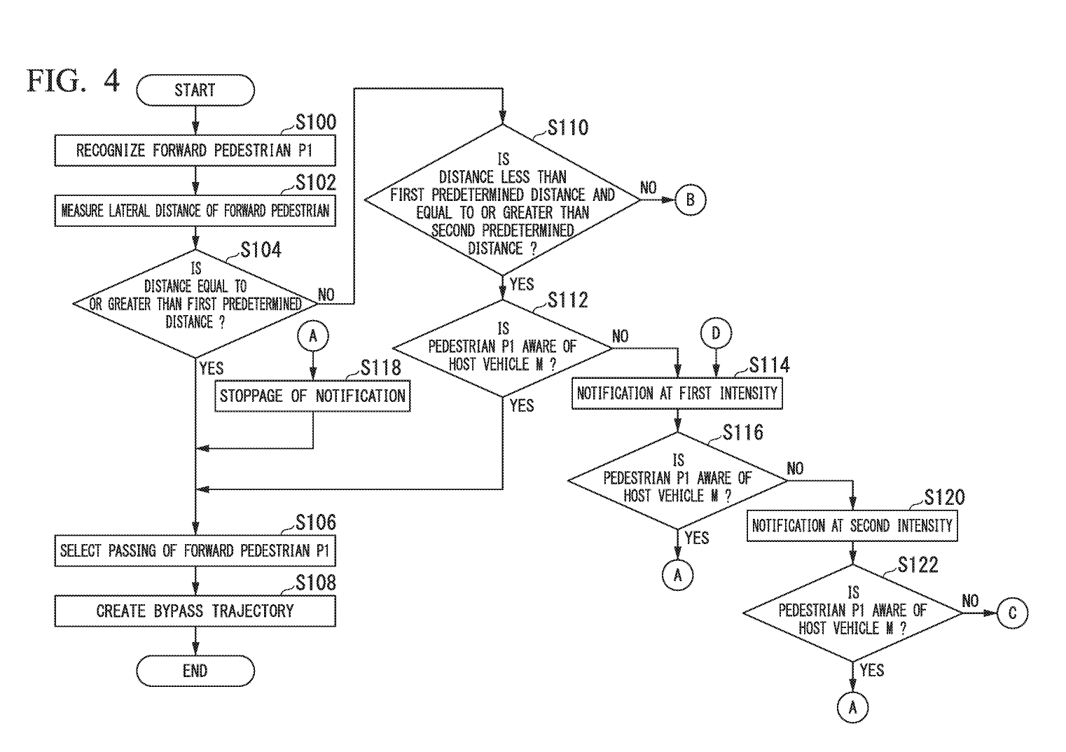

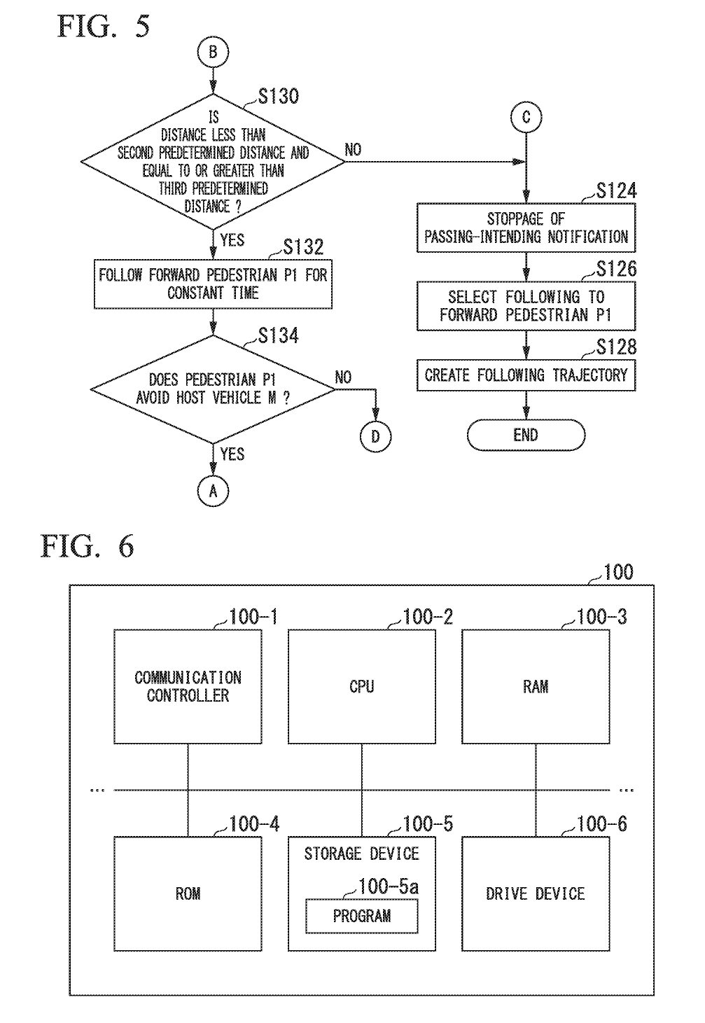

Hereinafter, description will be given of an example of a processing flow of a travel event that is executed by the automatic driving control device 100 in a case where the pedestrian P1 is recognized by the recognition unit 130 with reference to FIG. 4 and FIG. 5.

FIG. 4 and FIG. 5 is a flowchart showing a flow of processing executed by the automatic driving control device 100 according to this embodiment. For example, the processing of this flowchart may be repetitively executed at a predetermined cycle or at a predetermined timing.

In the example of FIG. 4 and FIG. 5, the traffic participant monitoring unit 134 recognizes the pedestrian P1 who exists in an advancing direction of the host vehicle M (step S100). The passing space recognition unit 132 measures a lateral distance such as the gap WR of the pedestrian P1 recognized by the traffic participant monitoring unit 134, and outputs the lateral distance to the traffic participant correspondence control unit 142 (step S102). The traffic participant correspondence control unit 142 determines whether or not the gap WR is equal to or greater than the first predetermined distance (step S104).

In a case where it is determined that the gap WR is equal to or greater than the first predetermined distance, the traffic participant correspondence control unit 142 selects passing of the pedestrian P1 (step S106). The action plan generation unit 140 creates a bypass trajectory of passing the pedestrian P1 (step S108).

In the processing in step S104, in a case where it is determined that the gap WR is not equal to or greater than the first predetermined distance, the traffic participant correspondence control unit 142 determines whether or not the gap WR is less than the first predetermined distance and equal to or greater than the second predetermined distance (step S110). In a case where it is determined that the gap WR is less than the first predetermined distance and equal to or greater than the second predetermined distance, the traffic participant monitoring unit 134 determines whether or not the pedestrian P1 is aware of the host vehicle M (step S112). In a case where it is determined that the pedestrian P1 is aware of the host vehicle M, if output of the notification information by the output unit 70 is performed, the notification control unit 180 stops the output (step S118). The action plan generation unit 140 performs step S106 and step S108.

In the processing in step S112, in a case where it is determined that the pedestrian P1 is not aware of the host vehicle M, the notification control unit 180 allows the output unit 70 to output notification information of the first intensity (step S114). The traffic participant monitoring unit 134 determines whether or not the pedestrian P1 is aware of the host vehicle M (step S116). In a case where it is determined that the pedestrian P1 is aware of the host vehicle M, the action plan generation unit 140 performs step S108 after step S118, and step S106.

In the processing in step S116, in a case where it is determined that the pedestrian P1 is not aware of the host vehicle M, the notification control unit 180 allows the output unit 70 to output notification information of the second intensity (step S120). The traffic participant monitoring unit 134 determines whether or not the pedestrian P1 is aware of the host vehicle M (step S122). In a case where it is determined that the pedestrian P1 is aware of the host vehicle M, the action plan generation unit 140 performs step S108 after step S118 and step S106.

In the processing in step S122, in a case where it is not determined that the pedestrian P1 is aware of the host vehicle M, the notification control unit 180 stops passing-intending notification (step S124). The traffic participant correspondence control unit 142 selects following to the pedestrian P1 (step S126). The action plan generation unit 140 creates a following trajectory of following the pedestrian P1 (step S128).

In the processing in step S110, in a case where it is determined that the gap WR is not in a range that is less than the first predetermined distance and equal to or greater than the second predetermined distance, the traffic participant correspondence control unit 142 determines whether or not the gap WR is less than the second predetermined distance and equal to or greater than the third predetermined distance (step S130). In a case where it is determined that the gap WR is less than the second predetermined distance and equal to or greater than the third predetermined distance, the traffic participant correspondence control unit 142 performs travel control of following the pedestrian P1 for a constant time (step S132).

The traffic participant monitoring unit 134 determines whether or not the pedestrian P1 sufficiently avoid the host vehicle M (step S134). In a case where it is determined that the pedestrian P1 sufficiently avoids the host vehicle M, the action plan generation unit 140 performs step S108 after step S118 and step S106.

In the processing in step S134, in a case where it is not determined that the pedestrian P1 sufficiently avoids the host vehicle M, step S114 is performed.

In the processing in step S130, in a case where it is determined that the gap WR is not in a range that less than the second predetermined distance and equal to or greater than the third predetermined distance, the action plan generation unit 140 performs step S126 and step S128. According to this, the processing of this flowchart is terminated.

According to the above-described embodiment, the vehicle control device includes the recognition unit 130 that recognizes a nearby situation of a vehicle, and the driving control units 120 and 160 which automatically controls at least steering of the host vehicle M on the basis of the nearby situation recognized by the recognition unit 130. In addition, in a case where the pedestrian P1 is recognized by the recognition unit 130 in an advancing direction of the host vehicle M the driving control units 120 and 160 generate a target trajectory in which an appropriate notification level is set by the traffic participant correspondence control unit 142 on the basis of a lateral distance of the pedestrian, and thus it is possible to appropriately execute a driving control and notification aspect for avoiding contact with a traffic participant.

Even during travelling on the basis of the target trajectory, it is possible to appropriately change a notification level by the notification control unit 180 on the basis of the latest determination result from the traffic participant monitoring unit 134 as to whether or not the recognized traffic participant is aware of the host vehicle M, and thus it is possible to adjust the degree of notification with respect to the pedestrian P1.

[Hardware Configuration]

FIG. 6 is a view showing an example of a hardware configuration of the automatic driving control device 100 according to this embodiment. As shown in the drawing, the automatic driving control device 100 has a configuration in which a communication controller 100-1, a CPU 100-2, a RAM 100-3 that is used as a working memory, a ROM 100-4 that stores a booting program, and the like, a storage device 100-5 such as a flash memory and an HDD, a drive device 100-6, and the like are connected through an internal bus or a dedicated communication line. The communication controller 100-1 performs communication with a constituent element other than the automatic driving control device 100. A program 100-5a that is executed by the CPU 100-2 is stored in the storage device 100-5. The program is developed in the RAM 100-3 by a direct memory access (DMA) controller (not shown), and is executed by the CPU 100-2. According to this, parts or the entirety of the first control unit 120, the second control unit 160, and the notification control unit 180 of the automatic driving control device 100 are realized.

The above-described embodiment can be expressed as follows.

A vehicle control device including:

a storage device that stores a program; and

a hardware processor,

wherein the hardware processor executes the program stored in the storage device to recognize a nearby situation of a vehicle, and to automatically control acceleration/deceleration and steering of the vehicle on the basis of the nearby situation that is recognized, and

in a case where a traffic participant who exists in an advancing direction of the vehicle is recognized, steering of the vehicle is automatically controlled to output information for notification of existence of the vehicle by adjusting the degree of notification on the basis of a distance between the traffic participant and an edge portion opposite to an edge portion closer to the traffic participant in a travel road of the vehicle.

In the above described embodiment, description has been given of an example in which the output unit 70 is the headlights 72 or the sound output unit 74. However, a notification method is not limited thereto, and for example, a hazard lamp of the host vehicle M may be lighted. For example, as the output unit 70, in a case where a digital signage which the traffic participant can visually recognize is provided, information (for example, a character, a mark, and the like) indicating a state of the host vehicle M may be output.

For example, output of the notification information may be performed by using a motion of the automatic driving control device 100 such as repetition of a motion of intentionally shortening or lengthening the distance between the traffic participant and the host vehicle M instead of using the output unit 70 by adjusting a speed of the host vehicle M instead of allowing the host vehicle M to follow the pedestrian P1 while maintaining an appropriate distance.

In the above-described embodiment, the output correlated to the notification level may be arbitrarily selected by a driver of the host vehicle M.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognition unit that recognizes a nearby situation of a vehicle;
a driving control unit that controls acceleration/deceleration and steering of the vehicle on the basis of the nearby situation that is recognized by the recognition unit;
an output unit that outputs information; and
a notification control unit that controls the output unit to output information for notification of existence of the vehicle in a case where a traffic participant who exists in an advancing direction of the vehicle is recognized by the recognition unit,
wherein the notification control unit adjusts the degree of notification with respect to the traffic participant on the basis of a distance between an edge portion that is disposed away from the traffic participant in a width direction of a road on which the vehicle travels, and the traffic participant.

2. The vehicle control device according to claim 1,
wherein the notification control unit does not allow the output unit to output information in a case where the distance recognized by the recognition unit is equal to or greater than a first determined distance, and
the notification control unit allows the output unit to output information on the basis of a predetermined condition in a case where the distance recognized by the recognition unit is less than the first predetermined distance.

3. The vehicle control device according to claim 1,
wherein in a case where the recognition unit recognizes that the traffic participant is not aware of existence of the vehicle after information is output by the output unit at first intensity, the notification control unit controls the output unit to output information at second intensity stronger than the first intensity.

4. The vehicle control device according to claim 2,
wherein in a case where the distance recognized by the recognition unit is less than a first predetermined distance and is equal to or greater than a third predetermined distance shorter than the first predetermined distance, the notification control unit allows the output unit to output information at first intensity.

5. The vehicle control device according to claim 4,
wherein in a case where an advancing direction of the traffic participant is the same as the advancing direction of the vehicle, and the distance recognized by the recognition unit is less than a second predetermined distance that is shorter than the first predetermined distance and is longer than the third predetermined distance, and is equal to or greater than the third predetermined distance, the driving control unit allows the vehicle to follow the traffic participant, and
after the recognition unit recognizes that the driving control unit allows the vehicle to follow the traffic participant, the notification control unit allows the output unit to output information at the first intensity.

6. The vehicle control device according to claim 4,
wherein in a case where an advancing direction of the traffic participant is the same as the advancing direction of the vehicle, and the distance recognized by the recognition unit is less than the third predetermined distance, the driving control unit allows the vehicle to follow the traffic participant, and
the notification control unit does not allow the output unit to output information.

7. The vehicle control device according to claim 1,
wherein in a case where the output unit is allowed to output information, and in a case where the recognition unit recognizes that the traffic participant is aware of existence of the vehicle, the notification control unit allows the output unit to stop outputting of information.

8. The vehicle control device according to claim 1,
wherein in a case where the output unit is allowed to output information for a predetermined output time or longer, and in a case where the recognition unit recognizes that the traffic participant is not aware of existence of the vehicle, the notification control unit allows the output unit to stop outputting of information.

9. A vehicle control method comprising:
recognizing a nearby situation of a vehicle by a vehicle control device;
automatically controlling acceleration/deceleration and steering of the vehicle by the vehicle control device on the basis of the nearby situation that is recognized; and
automatically controlling steering of the vehicle by the vehicle control device to output information for notification of existence of the vehicle by adjusting the degree of notification on the basis of a distance between an edge portion that is disposed away from a traffic participant in a width direction of a road on which the vehicle travels, and the traffic participant in a case where the traffic participant who exists in an advancing direction of the vehicle is recognized.

10. A non-transitory computer-readable storage medium that stores a program that allows a vehicle control device to:
recognize a nearby situation of a vehicle;
automatically control acceleration/deceleration and steering of the vehicle on the basis of the nearby situation that is recognized; and
automatically control steering of the vehicle to output information for notification of existence of the vehicle by adjusting the degree of notification with respect to a traffic participant on the basis of a distance between an edge portion that is disposed away from the traffic participant in a width direction of a road on which the vehicle travels, and a traffic participant in a case where the traffic participant who exists in an advancing direction of the vehicle is recognized.
